(19) United States
(12) Patent Application Publication
(10) Pub. No.: US 2009/0194628 A1
(43) Pub. Date: Aug. 6, 2009

(54) Strap reel

(76) Inventors: Glen R. Taylor, Benton, MO (US); Brenda Taylor, Benton, MO (US)

Correspondence Address: STRATTON BALLEW, 213 S 12TH AVE, YAKIMA, WA, 98902, US

(21) Appl. No.: 12/012,315

(22) Filed: Feb. 1, 2008

(51) Int. Cl. B65H 75/38; B60R 9/00

(52) U.S. Cl. 242/395; 24/132 R

(57) ABSTRACT

A strap reel for winding load securing straps is comprised of a base, an arbor, and a protruding element. The arbor is centered on a first side of the base, and is adapted to be received by a motorized drill. The protruding element is centered on the opposing side of the base, and is configured to receive the hook of the load securing strap. The strap reel provides an easy and quick way to wind straps for storage.

### CROSS-REFERENCE TO RELATED APPLICATIONS

This application claims priority of prior U.S. patent application Ser. No. 11/890,773 filed Aug. 6, 2007, which claims priority of prior U.S. provisional application Ser. No. 60/836,732, filed Aug. 9, 2006.

### BACKGROUND OF THE INVENTION

The use of binder or “ratchet” straps to secure loads on a flatbed trailer, whether a small utility type trailer or a semi tractor trailer, is commonplace. A typical ratchet strap is made up of a length of strap or webbing, with a wide flat metal hook on one end for securing the strap to the trailer. Ratchet straps are long and difficult to roll up for storage. The straps are typically rolled by hand, or put on a reel with a handle and wound up manually. This process is time consuming, and for drivers who are on tight schedules, saving time is important.

Several attempts have been made to provide devices for winding ratchet straps for storage. For example, U.S. Pat. No. 6,139,233 to Wilsey discloses a rapid spooling and tightening device for load straps. U.S. Pat. No. 6,868,872 to Perkins, Jr. discloses a device for winding a strap around a spool. U.S. Pat. No. 7,278,808 to Sisk, Sr. et al. discloses a driver for rewinding cargo straps. Each of these devices requires that the spooling device be mounted to a surface, such as a trailer bed. Furthermore, the Wilsey '233 device and the strap spools served by the Perkins '872 and Sisk, Sr. et al. '808 devices function as winding and storage devices, and thus can be used to wind and store only one strap. Where multiple straps are used, multiple spools are required.

### SUMMARY OF THE INVENTION

The strap reel of the present invention comprises a base, an arbor and a protruding element. The arbor is centered on one side of the base and is adapted to be engaged in a motorized drill. On the opposing side of said base is a protruding element for receiving the hook of the ratchet strap and winding the strap. The present invention will provide drivers of semi tractor trailer rigs an easy and quick way to roll ratchet straps for storage.

### DESCRIPTION OF DRAWINGS

FIG. 1 is an elevation view of the strap reel of the present invention;

FIG. 2 is an exploded section view of the strap reel of the present invention;

FIG. 3 is a perspective view of the strap reel of the present invention;

FIG. 4 is a plan view of the strap reel of the present invention showing the first side of the base, with the protruding element shown in dotted outline; and

FIG. 5 is a plan view of the strap reel of the present invention, showing the opposing side of the base.

### DETAILED DESCRIPTION OF INVENTION

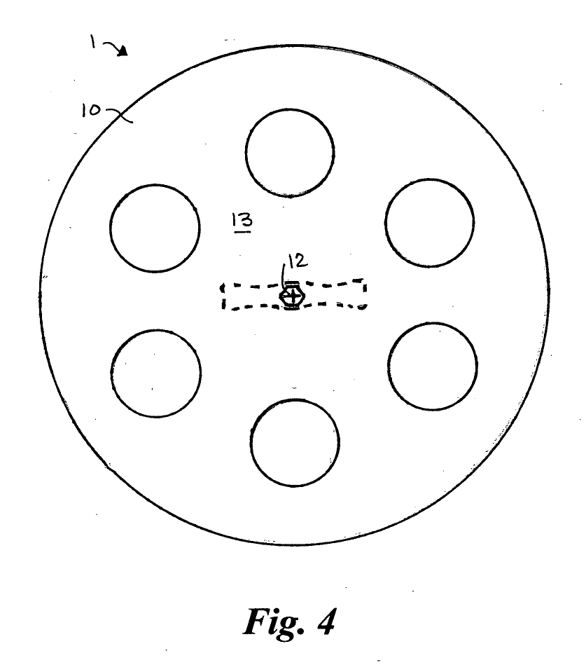

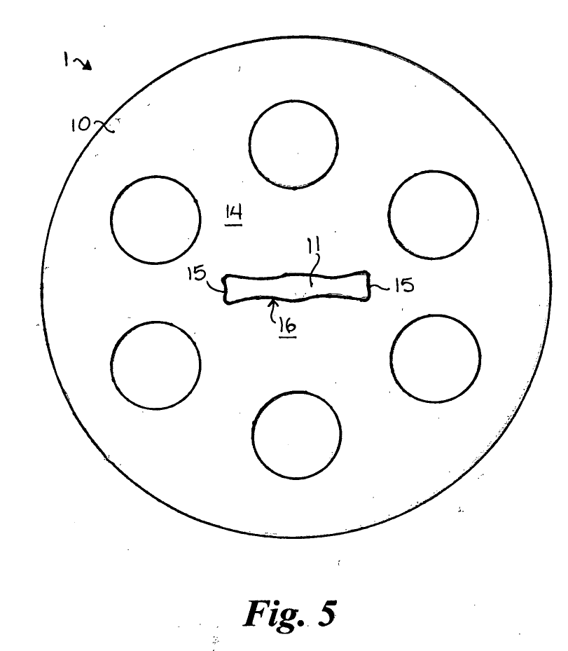

The strap reel 1 comprises a base 10, a protruding element 11, and an arbor 12. The base 10 is a substantially planar element which serves as an attachment point for the protruding element 11 and the arbor 12, and also provides a surface against which a ratchet strap is aligned as it is wound on the strap reel. In the embodiment shown in the attached drawings, the base is substantially circular in shape, although other base shapes are contemplated. The base may be constructed of hard molded plastic, metal or other suitable material. The inventor has had success using hard molded plastic approximately one quarter inch thick. In a preferred embodiment, the base has a plurality of apertures formed therein, as shown in FIGS. 4 and 5.

The base 10 includes a first side 13 and an opposing side 14. The arbor 12 is centered on the first side of the base and extends perpendicularly therefrom. The arbor is adapted to be engaged in a motorized drill. In the embodiment depicted in the attached drawings, the arbor is an elongated, substantially cylindrical shaft having a diameter that is sized to be received in the chuck of a standard motorized drill. In an embodiment of the invention, the arbor has a substantially polygonal cross section. This external shape prevents the arbor from slipping in the drill when the drill is in operation.

Centered on the opposing side 14 of the base 10 is a protruding element 11. The protruding element comprises a substantially flat rectangular element having opposing edges 15 that are substantially perpendicular to the base and parallel to the arbor 12, as shown in the attached drawings. The protruding element provides a means for receiving the hook end of a ratchet strap. The wide flat hook of a ratchet strap can be received on either edge 15 of the protruding element. To accommodate the hook of a standard ratchet strap, the protruding element is approximately three inches long and two and a half inches wide. Alternatively, the protruding element may be sized to accommodate hooks of other dimensions. In the preferred embodiment shown in FIGS. 4 and 5, the surface 16 of the protruding element is contoured.

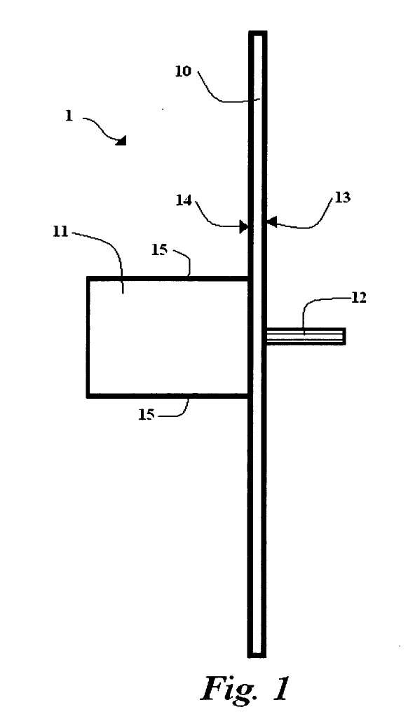

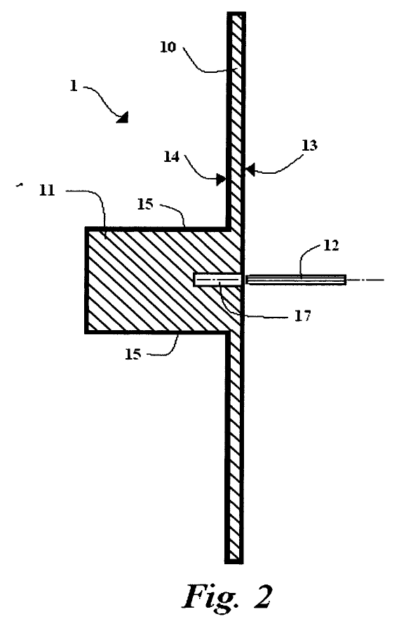

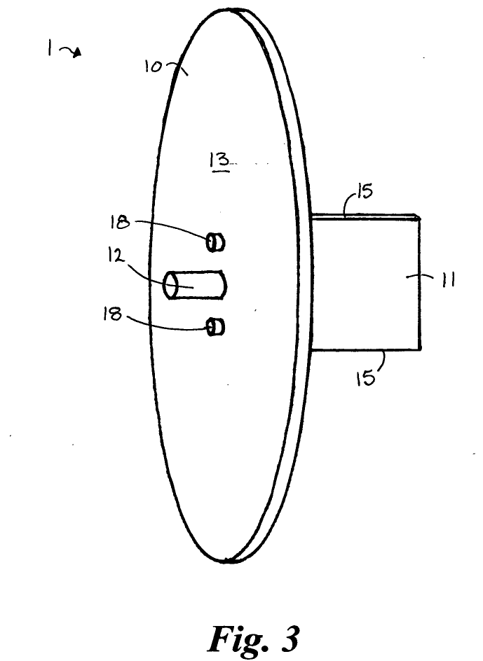

The strap reel 1 may be one solid unit comprised of molded plastic. Alternatively, the strap reel may be assembled from separate elements comprising the base 10, the arbor 12 and the protruding element 11, or combinations of those elements. In the preferred embodiment shown in FIGS. 1, 2, 4 and 5, the base and the protruding element comprise a contiguous molded unit, and the arbor comprises a metal shaft, which is inserted into an arbor aperture 17 extending through the base and into the protruding element 11, as shown in FIG. 2. The arbor can held in place by friction, adhesive, or any conventional means. In the embodiment shown in FIG. 3, the base, the arbor, and the protruding element comprise three discrete elements. In this embodiment, the protruding element is secured to the base with bolts 18.

### Mode of Operation

In use, a ratchet strap is wound on the strap reel for storage. The ratchet strap has a wide, flat metal hook on one end for securing the ratchet strap to a trailer bed or the like. With the base 10 in a vertical position, and the arbor 12 and protruding element 11 in a horizontal position, the ratchet strap hook is removably hooked or “hung” on an edge 15 of the protruding element so that the ratchet strap hangs vertically downward from the hook. The arbor is engaged in a motorized drill. With one hand holding the drill and the other hand guiding the ratchet strap, the drill is activated to begin turning the strap reel. As the strap reel turns, the ratchet strap is wound onto the protruding element guided by the user's hand and the flat opposing side 14 of the base. Once winding is complete, the wound ratchet strap can be slid off of the protruding element and stored in its wound condition. Because it is not used to store the ratchet strap, the strap reel can be used to wind as many ratchet straps as necessary.

In compliance with the statutes, the invention has been described in language more or less specific as to structural features and process steps. While this invention can be embodied in different forms, the specification describes and illustrates preferred embodiments of the invention. It will be understood that this disclosure is an exemplification of the principles of the invention, and is not intended to limit the invention to the particular embodiments described. Those with ordinary skill in the art will appreciate that other embodiments and variations of the invention, which employ the same inventive concepts as the invention, are possible. Therefore, the invention is not to be limited except by the following claims, as appropriately interpreted in accordance with the doctrine of equivalents.

I claim:

1. A strap reel for winding a ratchet strap comprising a strap and a hook affixed to the strap, the strap reel comprising:
a base, the base having a first side and an opposing side;
an arbor, the arbor centered on and extending substantially perpendicularly from the first side of the base, the arbor adapted to be engaged in a motorized drill; and
a protruding element, the protruding element centered on and extending substantially perpendicularly from the opposing side of the base, the protruding element for receiving the hook of the ratchet strap.

2. The strap reel of claim 1, wherein the protruding element comprises a substantially flat rectangular element having opposing edges that are substantially perpendicular to the base.

3. The strap reel of claim 2, wherein the protruding element further comprises a contoured surface.

4. The strap reel of claim 1, wherein the base and the protruding element comprise a contiguous molded unit.

5. The strap reel of claim 1, wherein the base is substantially circular in shape.

6. The strap reel of claim 1, wherein the arbor has a substantially polygonal cross section.

7. A method for winding a ratchet strap for storage using a strap reel and a motorized drill, the ratchet strap comprising a strap and a hook affixed to the strap, and the strap reel comprising a base having a first side and an opposing side, an arbor, the arbor centered on and extending substantially perpendicularly from the first side of the base, the arbor adapted to be engaged in a motorized drill, and a protruding element, the protruding element centered on and extending substantially perpendicularly from the opposing side of the base, the protruding element adapted to receive the hook of the ratchet strap, the method including the steps of:
engaging the hook of the ratchet strap on the protruding element;
engaging the arbor of the strap reel in the motorized drill; and,
activating the drill to turn the strap reel and wind the strap onto the protruding element.

8. The method of claim 7, further comprising the steps of:
sliding the wound ratchet strap off of the protruding element; and
storing the wound ratchet strap in its wound condition.
